(19) United States
(12) Patent Application Publication
(10) Pub. No.: US 2026/0292601 A1
(43) Pub. Date: Sep. 24, 2026

(54) ENABLING PROTOCOL DATA UNIT SET BASED QUALITY OF SERVICE HANDLING FOR EXTENDED REALITY SERVICES

(71) Applicant: GOOGLE LLC, Mountain View, CA (US)

(72) Inventor: Chih-Hsiang Wu, Taoyuan City (TW)

(21) Appl. No.: 19/473,051

(22) PCT Filed: Apr. 8, 2024
(86) PCT No.: PCT/US2024/023614

§ 371 Date: Oct. 6, 2025

Related U.S. Application Data
(60) Provisional application No. 63/494,758, filed on Apr. 6, 2023.

(51) Int. Cl. H04W 28/24

(52) U.S. Cl. CPC H04W 28/24

(57) ABSTRACT

A radio access network (RAN) node acting as a base station or core network (CN) can implement a method for managing lower layer triggered mobility protocol procedure(s). An example method in a core network (CN) includes: transmitting, to a base station via which a user equipment (UE) communicates with the CN, a request for resources for a packet data unit (PDU) session, including; determining, based on a condition related to the UE and/or the base station, whether to include a PDU Set quality of service (QoS) parameter in the request; and receiving, from the base station, a response to the request for the resources.

### CROSS-REFERENCE TO RELATED APPLICATIONS

This application claims priority to and the benefit of the filing date of provisional U.S. Patent Application No. 63/494,758 entitled “ENABLING PROTOCOL DATA UNIT SET BASED QUALITY OF SERVICE HANDLING FOR EXTENDED REALITY SERVICES,” filed on Apr. 6, 2023. The entire contents of the provisional applications are hereby expressly incorporated herein by reference.

### FIELD OF THE DISCLOSURE

This disclosure relates to wireless communications and, more particularly, to enabling setup or modification of radio resources for high data rate and low latency services such as extended Reality (XR) services and cloud gaming.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer. A core network communicates data with the UE via the RAN using multiple layers of a protocol stack.

XR stands for extended Reality, which is an umbrella term that covers Augmented Reality (AR), Virtual Reality (VR) and Mixed Reality (MR). In virtual reality, the user is fully immersed in a virtual environment that is totally substituting the real environment by wearing a head-mounted device. Augmented reality augments the perception of the real environment with some virtual elements, so some virtual elements are overlaid on the perception of the real environment. Mixed reality is an extension of AR where the real and virtual elements can interact in real time. Cloud gaming runs video games on remote servers without the need for a gaming console or a high spec CPU and GPU to play these games. Cloud gaming streams a game like streaming a video, and the game will respond to the gamer commands and controls in real time.

XR services and cloud gaming require high data rate and low latency transmission. Recently new quality of service requirements to support XR services and cloud gaming have been developed. However, it is not clear how to support the new quality of service requirements in the RAN and core network.

### SUMMARY

An example embodiment of the techniques of this disclosure is a method implemented in a core network, the method comprising: transmitting, to a base station via which a user equipment (UE) communicates with the CN, a request for resources for a packet data unit (PDU) session, including: determining, based on a condition related to the UE and/or the base station, whether to include a PDU Set quality of service (QOS) parameter in the request; and receiving, from the base station, a response to the request for the resources.

Another example embodiment of these techniques is a method implemented in a base station, the method comprising: receiving, from a core network (CN) for a user equipment (UE), a request for resources for a packet data unit (PDU) session, the request including a parameter pertaining to one of (i) a PDU Set quality of service (QOS) or an extended Reality (XR) service; determining, based on a condition related to the UE, whether to communicate a data packet between the UE and the CN using information corresponding to the parameter; and communicating the data packet in accordance with the determining.

Another example embodiment of these techniques is a device comprising processing hardware and configured to implement the methods above.

### BRIEF DESCRIPTION OF THE DRAWINGS

FIG. 1 is a block diagram of an example wireless communication system in which a user device and a base station of this disclosure can implement the techniques of this disclosure for enabling communication for high data rate and low latency services;

FIG. 2 is a block diagram of an example protocol stack according to which the UE of FIG. 1 communicates with base stations;

FIG. 3 is a messaging diagram of an example scenario in which a UE, a RAN, and a CN implement the techniques of this disclosure to support high data rate and low latency services;

FIG. 4A is a flow diagram of an example method for configuring a UE with a PDU set QoS parameters, which can be implemented in a CN of FIG. 1;

FIG. 4B is a flow diagram of a method similar to that of FIG. 4A, but in which the CN further determines where the base station successfully applied the PDU set QoS parameters;

FIG. 5A a flow diagram of an example method for transmitting PDU Set QoS parameters to a base station, which can be implemented in a CN of FIG. 1;

FIG. 5B is a flow diagram of a method similar to that of FIG. 5A, but in which the CN determines whether the UE subscribes to services that require PDU set-based QoS handling, rather than whether UE requested a service that requires PDU set-based QoS handling;

FIG. 5C is a flow diagram of a method similar to that of FIG. 5A, but in which the CN checks both the request condition of FIG. 5A and the subscription condition of FIG. 5B;

FIG. 5D is a flow diagram of a method similar to that of FIG. 5C, but in which the CN additionally checks whether the base station supports PDU set handling;

FIG. 6A a flow diagram of an example method for performing PDU set-based QoS handling of data received from the CN, which can be implemented in a base station of FIG. 1;

FIG. 6B is a flow diagram of a method similar to that of FIG. 6A, but in which the base station determines whether the UE supports PDU set handling;

FIG. 6C is a flow diagram of a method similar to that of FIG. 6A, but in which the base station determines whether the message from the CN includes PDU set QoS parameters;

FIG. 6D is a flow diagram of a method similar to that of FIG. 6A, but in which the base station checks both the UE support condition of FIG. 6B and the message condition of FIG. 6C;

FIG. 7A a flow diagram of an example method for generating configuration for an XR services and configuring a UE, which can be implemented in a base station of FIG. 1;

FIG. 7B is a flow diagram of a method similar to that of FIG. 7A, but in which the base station determines whether the UE supports features or functions related to XR data communication; and

FIG. 7C is a flow diagram of a method similar to that of FIG. 7A, but in which the base station determines whether the request for a PDU session resources includes parameters for an XR service.

### DETAILED DESCRIPTION OF THE DRAWINGS

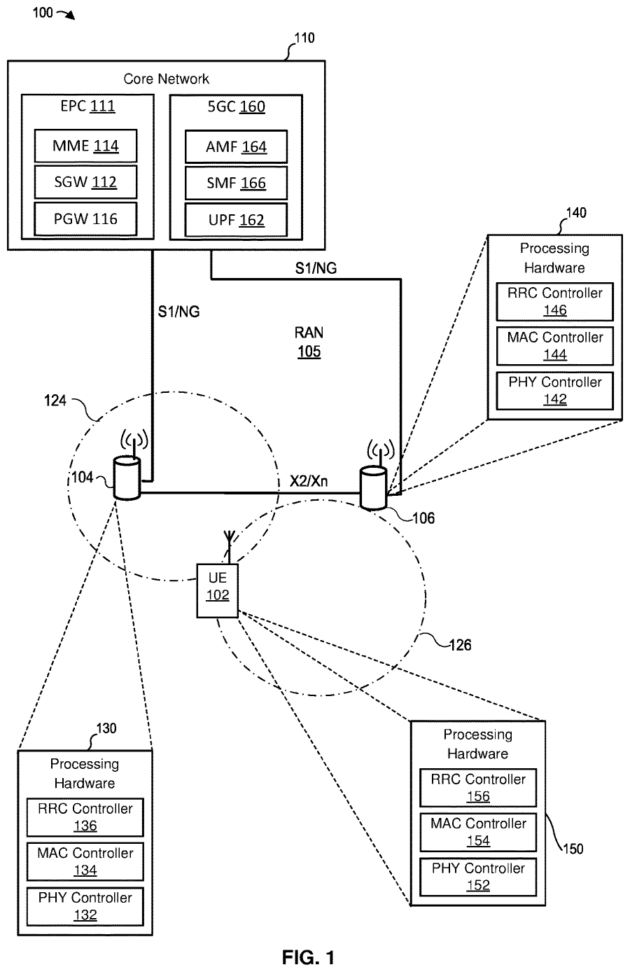

FIG. 1 depicts an example wireless communication system 100 in which communication devices can implement these techniques. The wireless communication system 100 includes a UE 102, a base station (BS) 104, a base station 106 and a core network (CN) 110. The UE 102 initially connects to the base station 104. In some scenarios, the base station 104 can perform an SN addition to configure the UE 102 to operate in dual connectivity (DC) with the base station 104 and the base station 106. The base stations 104 and 106 operate as an MN and an SN for the UE 102, respectively.

In various configurations of the wireless communication system 100, the base station 104 can be implemented as a master eNB (MeNB) or a master gNB (MgNB), and the base station 106 can be implemented as a secondary gNB (SgNB). The UE 102 can communicate with the base station 104 and the base station 106 via the same RAT such as EUTRA or NR, or different RATs. When the base station 104 is an MeNB and the base station 106 is a SgNB, the UE 102 can be in EUTRA-NR DC (EN-DC) with the MeNB and the SgNB.

In some cases, an MeNB or an SeNB is implemented as an ng-eNB rather than an eNB. When the base station 104 is a Master ng-eNB (Mng-eNB) and the base station 106 is a SgNB, the UE 102 can be in next generation (NG) EUTRA-NR DC (NGEN-DC) with the Mng-eNB and the SgNB. When the base station 104 is an MgNB and the base station 106 is an SgNB, the UE 102 may be in NR-NR DC (NR-DC) with the MgNB and the SgNB. When the base station 104 is an MgNB and the base station 106 is a Secondary ng-eNB (Sng-eNB), the UE 102 may be in NR-EUTRA DC (NE-DC) with the MgNB and the Sng-eNB.

In the scenarios where the UE 102 hands over from the base station 104 to the base station 106, the base stations 104 and 106 operate as the source base station (S-BS) and a target base station (T-BS), respectively. The UE 102 can operate in DC with the base station 104 and an additional base station (not shown in FIG. 1) for example prior to the handover. The UE 102 can continue to operate in DC with the base station 106 and the additional base station or operate in single connectivity (SC) with the base station 106, after completing the handover. The base stations 104 and 106 in this case operate as a source MN (S-MN) and a target MN (T-MN), respectively.

A core network (CN) 110 can be an evolved packet core (EPC) 111 or a fifth-generation core (5GC) 160, both of which are depicted in FIG. 1. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. To directly exchange messages with each other during the scenarios discussed below, the base stations 104 and 106 can support an X2 or Xn interface. Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage Protocol Data Unit (PDU) sessions.

As illustrated in FIG. 1, the base station 104 supports cell 124, and the base station 106 supports a cell 126. The cells 124 and 126 can partially overlap, so that the UE 102 can communicate in DC with the base station 104 and the base station 106, where one of the base stations 104 and 106 is an MN and the other is an SN. The base station 104 and base station 106 can support additional cell(s) (not shown in FIG. 1). The base station 104 can operate the cells 124 and/or additional cell(s) via one or more transmit and receive points (TRPs). More particularly, when the UE 102 is in DC with the base station 104 and the base station 106, one of the base stations 104 and 106 operates as an MeNB, an Mng-eNB or an MgNB, and the other operates as an SgNB or an Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

With continued reference to FIG. 1, the base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical downlink (DL) channels and DL reference signals with one or more user devices (e.g., UE 102) via one or more cells and/or one or more TRPs. The PHY controller 132 is also configured to receive data and control signal on physical uplink (UL) channels and/or UL reference signals with the one or more user devices via one or more cells and/or one or more TRPs. The processing hardware 130 in an example implementation includes a MAC controller 134 configured to perform MAC functions with one or more user devices. The MAC functions include a random access (RA) procedure, managing UL timing advance for the one or more user devices, and/or communicating UL/DL MAC PDUs with the one or more user devices. The processing hardware 130 can further include a RLC controller (not show in FIG. 1) configured to perform RLC functions with one or more user devices. The processing hardware 130 can further include a PDCP controller (not show in FIG. 1) configured to perform PDCP functions with one or more user devices. The processing hardware 130 can further include an RRC controller 136 to implement procedures and messaging at the RRC sublayer of the protocol communication stack. For example, the RRC controller 132 may be configured to support RRC messaging associated with resource configuration and reconfiguration procedure, handover procedures, and/or to support the necessary operations when the base station 104 operates as an MN relative to an SN or as an SN relative to an MN.

The base station 106 can include processing hardware 140 that is similar to processing hardware 130. In particular, components 142, 144, and 146 can be similar to the components 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more cells and/or one or more TRPs. The PHY controller 152 is also configured to transmit data and control signal on physical UL channels and/or UL reference signals with the base station 104 or 106 via one or more cells and/or one or more TRPs. The processing hardware 150 in an example implementation includes a MAC controller 154 configured to perform MAC functions with base station 104 or 106. For example, the MAC functions include a random-access procedure, managing UL timing for communication with the base station 104 or 106, and communicating UL/DL MAC PDUs with the base station 104 or 106. The processing hardware 150 can further include an RRC controller 156 to implement procedures and messaging at the RRC sublayer of the protocol communication stack. The processing hardware 130 can further include a RLC controller (not show in FIG. 1) configured to perform RLC functions with the base station 104 or 106. The processing hardware 130 can further include a PDCP controller (not show in FIG. 1) configured to perform PDCP functions with the base station 104 or 106.

In operation, the UE 102 in DC can use a radio bearer (e.g., a DRB or an SRB) that at different times terminates at the MN 104 or the SN 106. The UE 102 can apply one or more security keys when communicating on the radio bearer, in the uplink (UL) (from the UE 102 to a base station) and/or downlink (from a base station to the UE 102) direction.

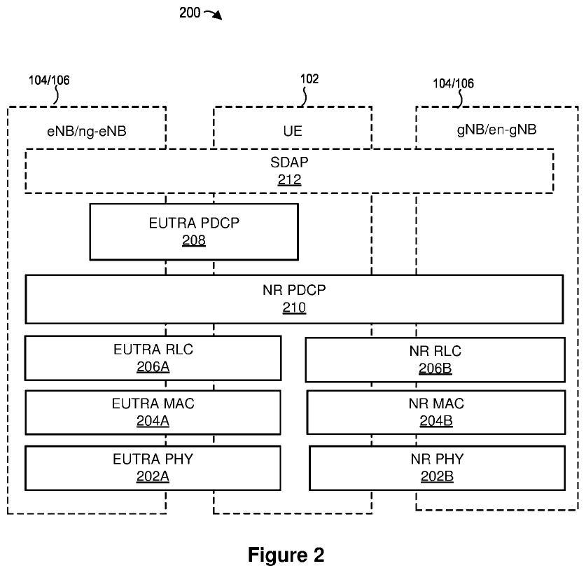

FIG. 2 illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

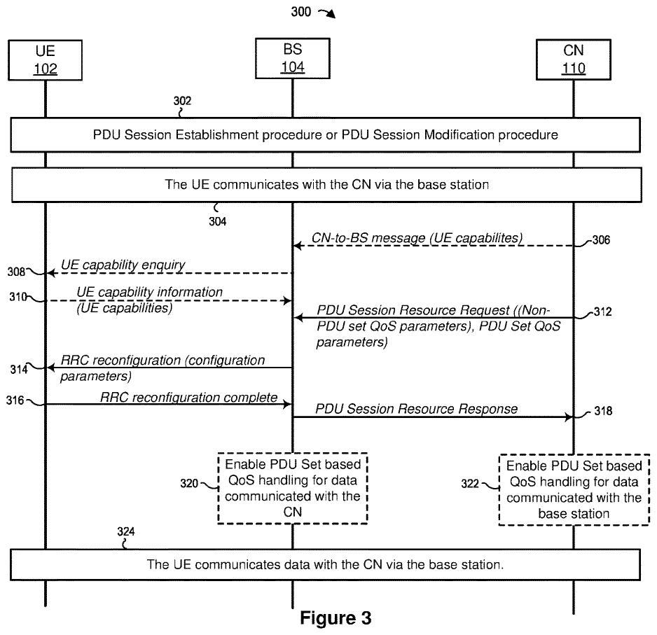

FIG. 3 is a messaging diagram of an example scenario in which a UE and nodes of a RAN and a CN implement the techniques of this disclosure for enabling communication for high-data-rate and low-latency services.

Referring to FIG. 3, in a scenario 300A, the UE 102 initially performs 302 a PDU Session Establishment procedure or a PDU Session Modification procedure with the CN 110 via the base station 104 or the base station 106 (not shown in FIG. 3) to establish or modify a PDU session that can support one or more services requiring a high data rate and low latency of transmission. Examples of such services include XR services and cloud games. During the PDU Session Establishment procedure, the UE 102 transmits a PDU Session Establishment Request message to the CN 110 via the base station (e.g., the base station 104 or 106). In some implementations, in response, the CN 110 sends a PDU Session Establishment Accept message to the CN 110 via the base station. In response to the PDU Session Establishment Accept message, the UE 102 then transmits a PDU Session Establishment Complete message to the CN 110 via the base station. In the PDU Session Modification procedure, the UE 102 transmits a PDU Session Modification Request message to the CN 110 via the base station. In some implementations, in response, the CN 110 sends a PDU Session Modification Command message to the CN 110 via the base station. In response to the PDU Session Modification Command message, the UE 102 then transmits a PDU Session Modification Complete message to the CN 110 via the base station.

In some implementations, the UE 102 includes, in the PDU Session Establishment Request message or PDU Session Modification Request message, a PDU session ID identifying the PDU session, slice information, and/or a particular data network name (DNN). In some implementations, the CN 110 includes the PDU session ID in the PDU Session Establishment Accept message or PDU Session Modification Command message to indicate that the PDU session is established or modified successfully. In some implementations, the slice information indicates a specific slice configured for the service(s). For example, the slice information is a Single Network Slice Selection Assistance Information (S-NSSAI) or includes a portion of the S-NSSAI. In other implementations, the UE 102 includes, in the PDU Session Establishment Request message or PDU Session Modification Request message, UE-requested quality of service (QOS) parameters that the UE 102 requires to perform the service(s).

After performing the procedure 302, the UE 102 communicates 304 with the CN 110 via the base station 104. While communicating with the UE 102, the base station 104 receives 306 a CN-to-BS message including UE capabilities of the UE 102 from the CN 110. Alternatively, the base station 104 transmits 308 a UE capability enquiry message to the UE 102 to obtain the UE capabilities. In response, the UE 102 transmits 310 a UE capability information message including the UE capabilities. In some implementations, the UE capabilities include capabilities indicating support of one or more functions/features for communication of data (e.g., XR data or cloud gaming data). For example, the function(s)/feature(s) include Multiple configured grant (CG) Physical Uplink Shared Channel (PUSCH) transmission occasions in a period of a single CG PUSCH configuration, dynamic indication of unused CG PUSCH occasion(s) based on UCI by the UE, buffer status reporting (BSR) enhancements, including at least new buffer status table(s), delay reporting of buffered data in uplink, provision of XR traffic assistance information for DL and UL (e.g. periodicity), and/or PDU Set handling (e.g., discard operation of PDU Sets). A PDU Set includes one or more PDUs carrying a payload of one unit of information generated at the application level (e.g. frame(s) or video slice(s) etc. for XR services).

During or after the procedure 302 or during the communication 304, the CN 110 transmits 312 a PDU Session Resource Request message to the base station 104 to request the base station 104 to assign resources for the PDU session and one or more QoS flows for the UE 102. The QoS flow(s) are associated with the PDU session. In some implementations, the CN 110 includes PDU Set QoS parameters in the PDU Session Resource Request message to request the base station 104 to apply PDU Set based QoS handling for the PDU session or the QoS flow(s). The base station 104 applies the PDU Set QoS parameters to communicate data with the UE 102 after (e.g., in response to) receiving the PDU Set QoS parameters. In some implementations, the PDU Set QoS parameters include or indicate PDU Set Delay Budget (PSDB), PDU Set Error Rate (PSER), PDU Set Integrated Handling Information (PSIHI). In some implementations, the CN 110 includes a (corresponding) set of PDU Set QoS parameters for each of the QoS flow(s) indicated in the PDU Session Resource Request message. In such cases, the base station 104 applies the corresponding set of PDU Set QoS parameters to communicate data associated with the each QoS flow with the UE 102.

In some implementations, the CN 110 includes, in the PDU Session Resource Request message, one or more non-PDU Set QoS parameters (i.e., QoS parameter(s) not related to a PDU Set). In some implementations, the base station 104 includes a (corresponding) set of non-PDU Set QoS parameter(s) for the PDU Session or each of the QoS flow(s). In other implementations, the CN 1102 does not include, in the PDU Session Resource Request message, non-PDU Set QoS parameters for the PDU session or some or all of the QoS flow(s). In some implementations, the non-PDU Set QOS parameters include a QoS flow identifier, a QoS identifier descriptor, a maximum flow bit rate for DL, a maximum flow bit rate for UL, a guaranteed flow bit rate for DL, and/or a guaranteed flow bit rate for UL.

After (e.g., in response to) receiving the PDU Session Resource Request message, the base station 104 assigns resources for the PDU session and one or more QoS flows for the UE 102 and generates configuration parameters for communicating data associated with the PDU session or the QoS flow(s) with the UE 102. The base station 104 transmits 314 a RRC reconfiguration message including the configuration parameters to the UE 102. In response, the UE 102 transmits 316 a RRC reconfiguration complete message to the base station 104.

In some implementations, the configuration parameters include one or more DRB configurations configuring one or more DRBs associated with the PDU session and/or QoS flow(s). In some implementations, each of the DRB configuration(s) includes a PDCP configuration. In some implementations, the configuration parameters include one or more RLC bearer configurations, each configuring a RLC bearer for a particular DRB, and/or include a MAC configuration. In some implementations, the base station 104 configures one or more configuration parameters in the MAC configuration, PDCP configuration(s) and/or RLC bearer configuration(s) based on the PDU Set QoS parameters. In some implementations, the base station 104 assigns resources for the UE 102 based on the PDU Set QoS parameters. In some cases, for the non-PDU Set QOS parameters, the base station 104 additionally considers the non-PDU Set QoS parameters when configuring the configuration parameter(s) and/or assigning resources for the UE 102. By properly assigning resources for the UE 102 and/or configuring the configuration parameter(s), the base station 104 ensures that data associated with the PDU session or QoS flow(s) is communicated with the UE 102 in compliance with the PDU Set QoS parameters and/or non-PDU Set QoS parameters.

The base station 104 transmits 318 a PDU Session Resource Response message to the CN 110 in response to receiving the PDU Session Resource Request message. In some implementations, the base station 104 transmits the PDU Session Resource Response message before or after receiving the RRC reconfiguration complete message. In some implementations, the base station 104 includes, in the PDU Session Resource Response message, confirmation information indicating that the base station 104 supports the PDU Set QoS parameters or PDU Set based QoS handling. In other implementations, if the base station 104 does not support the PDU Set QoS parameters or PDU Set based QoS handling, the base station 104 includes information (e.g., a cause value) in the PDU Session Resource Response message to indicate that the base station 104 does not support the PDU Set QoS parameters or PDU Set based QoS handling. In some alternative implementations, the base station 104 implicitly indicates that the base station 104 supports the PDU Set QoS parameters or PDU Set based QoS handling by excluding the information (e.g., a cause value) in the PDU Session Resource Response message to indicate that the base station 104 supports the PDU Set QoS parameters or PDU Set based QoS handling.

In some implementations, the PDU Session Resource Request message and the PDU Session Resource Response message are a PDU Session Resource Setup Request message and a PDU Session Resource Setup Response message, respectively. In other implementations, the PDU Session Resource Request message and the PDU Session Resource Response message are a PDU Session Resource Modify Request message and a PDU Session Resource Modify Response message, respectively.

After receiving the PDU Session Resource Response message, the CN 110 communicates 324 data packets (e.g., data packets for XR or clouding gaming) with the UE 102 via the base station 104. In some implementations, the CN 110 transmits 324 data packets for the UE 102 to the base station 104 based on a GPRS Tunneling Protocol User Plane (GTP-U) protocol. The data packets in the event 324 are associated with a QoS flow configured or indicated in the PDU Session Resource Request message. In some implementations, the CN 110 performs PDU Set QoS handling to transmit 324 data packets to the base station 104 based on the PDU Set QoS parameters. To perform PDU Set based QoS handling, the CN 110 groups data packets for the UE 102 into PDU Sets and determines PDU Set information for each data packet in each PDU Set. The PDU Set information includes at least one of a PDU Set Sequence Number, an indication of End PDU of the PDU Set (i.e., the last data packet in the PDU Set), a PDU Sequence Number (i.e., a sequence number for a data packet) within a PDU Set, a PDU Set Size in bytes, and/or PDU Set Importance which identifies the relative importance of a PDU Set compared to other PDU Sets within the QoS Flow. For each data packet to be transmitted to the UE 102 in the event 324, the CN 110 generates a GTP-U packet including the data packet and PDU Set information for a PDU Set where the data packet belongs. In some implementations, the CN 110 includes the PDU Set information in a GTP-U header of the GTP-U packet. When the base station 104 receives the GTP-U packet, the base station 104 performs PDU Set based QoS handling for the data packet in the GTP-U packet, based on the PDU Set information and the PDU Set QoS parameters. For example, the base station 104 uses the PDU Set Importance for PDU Set level packet discarding in case of congestion at the base station 104. In another example, the base station 104 prioritizes transmission for a first data packet within a PDU Set over a second data packet, based on a first PDU Sequence Number and a second PDU Sequence Number for the first data packet and second data packet respectively. If the first PDU Sequence Number indicates that the first data packet is generated before the second data packet associated with the second PDU Sequence Number, the base station 104 transmits the first data packet to the UE 102 before transmitting the second data packet. The base station 104 transmits 324 the data packets received from the CN 110 to the UE 102 using the configuration parameters.

In some implementations, the base station 104 schedules the UE 102 to transmit 324 data packets based on the PDU Set QoS parameters and/or non-PDU Set QoS parameters. Specifically, the base station 104 ensures that data packets received from the UE 102 and transmitted to the CN 110 follow the PDU Set QoS parameters and/or non-PDU Set QoS parameters. In some implementations, when the base station 104 receives a data packet from the UE 102 in the event 324, the base station 104 generates a GTP-U packet including the data packet and does not include PDU Set information in the GTP-U packet. In one implementation, the base station 104 does not include PDU Set information in the GTP-U packet because the UE 102 does not transmit PDU Set information for the data packet to the base station 104. In some implementations, if the UE 102 transmits PDU Set information for the data packet to the base station 104, the base station 104 includes the PDU Set information in the GTP-U packet. For example, the base station 104 includes the PDU Set information in a GTP-U header of the GTP-U packet.

In some implementations, the CN 110 enables 322 the PDU Set based QoS handling, after (e.g., in response to) receiving the PDU Session Resource Response message. In some implementations, the base station 104 enables 320 the PDU Set based QoS handling in response to receiving 312 the PDU Session Resource Request message or PDU Set QoS parameters. Later, if the base station 104 receives a PDU Session Resource Release Command message for the PDU session, the base station 104 disables PDU Set based QoS handling. In some implementations, if the base station 104 receives a PDU Session Resource Request message from the CN 110, excluding PDU Set QoS parameters, for a PDU session for a UE (e.g., the UE 102 or another UE), the base station 104 disables PDU Set based QoS handling for the PDU session.

In some implementations, if the base station 104 does not support the PDU Set based QoS handling and receives 324, from the CN 110, GTP-U packets each including a data packet and PDU Set information, the base station 104 ignores the PDU Set information. In some implementations, if the CN 110 determines that the base station 104 does not support the PDU Set based QoS handling, the CN 110 refrains from including PDU Set information in a GTP-U packet that includes a data packet for the UE 102.

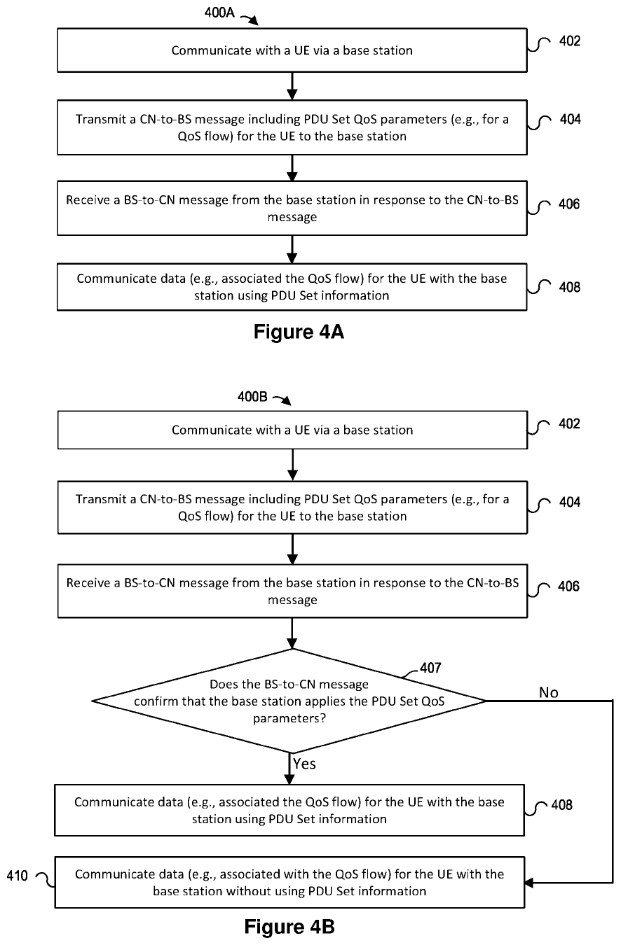

FIG. 4A is a flow diagram of an example method 400A for transmitting PDU Set QoS parameters to a base station (e.g., the base station 104 or 106) for PDU Set based QoS handling, which a CN (e.g., the CN 110 or AMF 164) can implement.

The method 400A begins at block 402, where the CN communicates with a UE (e.g., UE 102) via a base station (e.g., events 302, 304). At block 404, the CN transmits a CN-to-BS message including PDU Set QoS parameters (e.g., for a QoS flow) for the UE to the base station (e.g., event 312). At block 406, the CN receives a BS-to-CN message from the base station in response to the CN-to-BS message (e.g., event 318). At block 408, the CN communicates data (e.g., of the QoS flow) for the UE with the base station using PDU Set information (e.g., event 324).

FIG. 4B is a flow diagram of an example method 400B similar to the method 400A, except that the method 400B includes blocks 407 and 410. At block 407, the CN determines whether the BS-to-CN message confirms that the base station applies the PDU Set QoS parameters. If the CN determines that the BS-to-CN message confirms that the base station applies the PDU Set QoS parameters at block 407, the flow proceeds to block 408. Otherwise, if the CN determines that the BS-to-CN message does not confirm that the base station applies the PDU Set QoS parameters at block 407, the flow proceeds to block 410. At block 410, the CN communicates data (e.g., associated with the QoS flow) for the UE with the base station without using PDU set information (e.g., event 324).

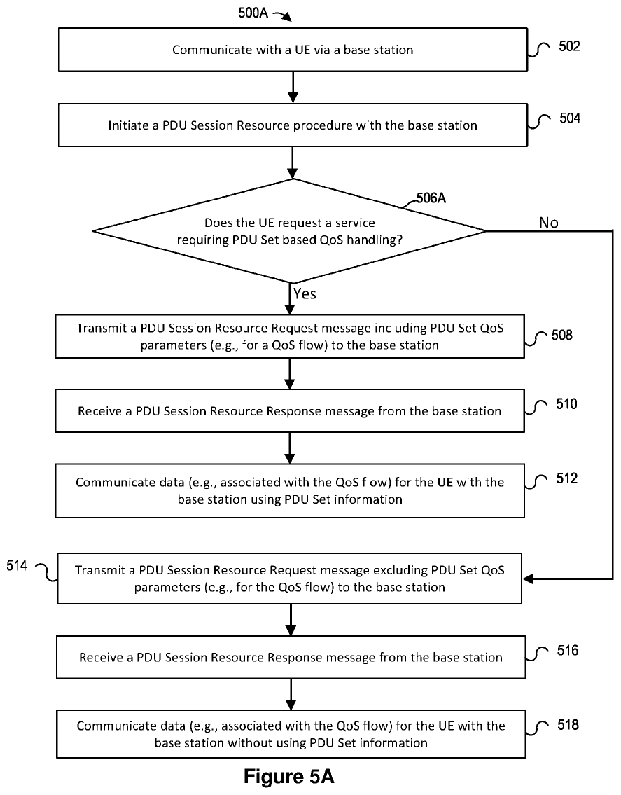

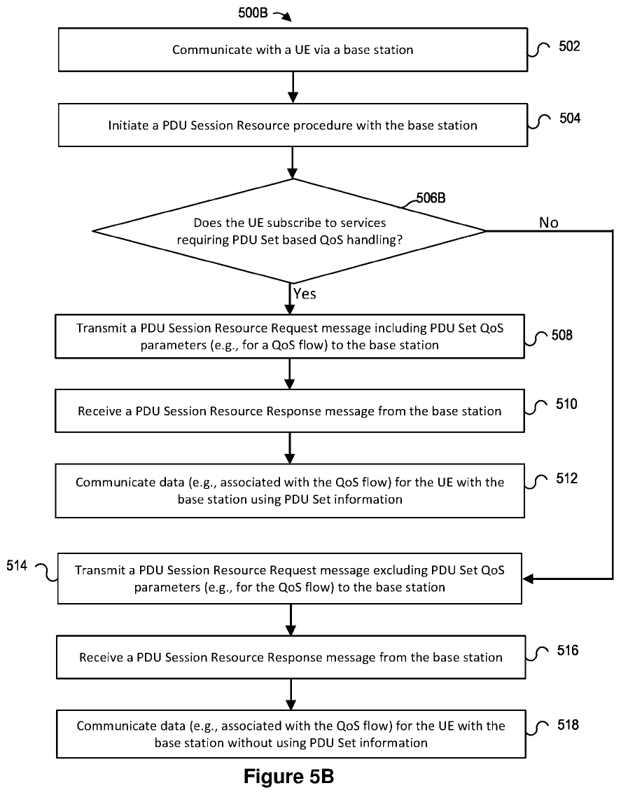

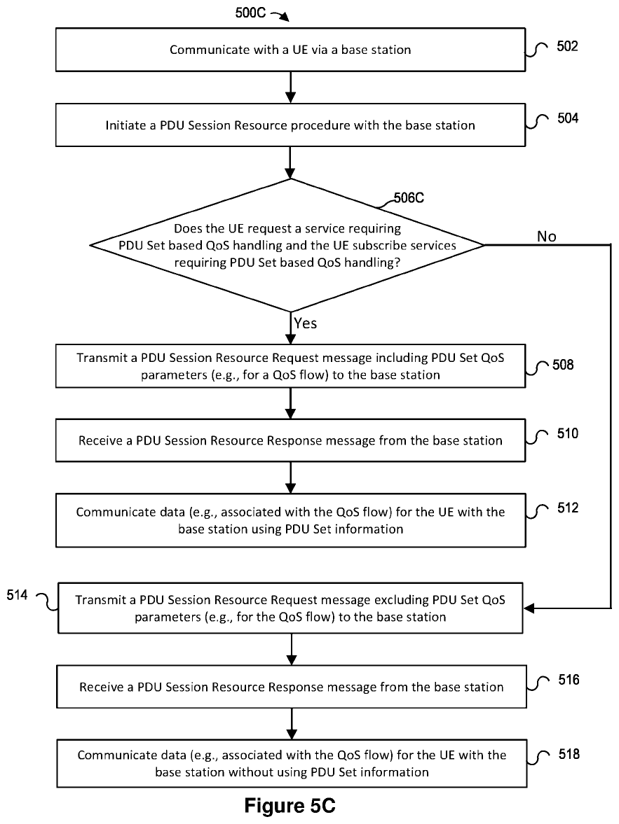

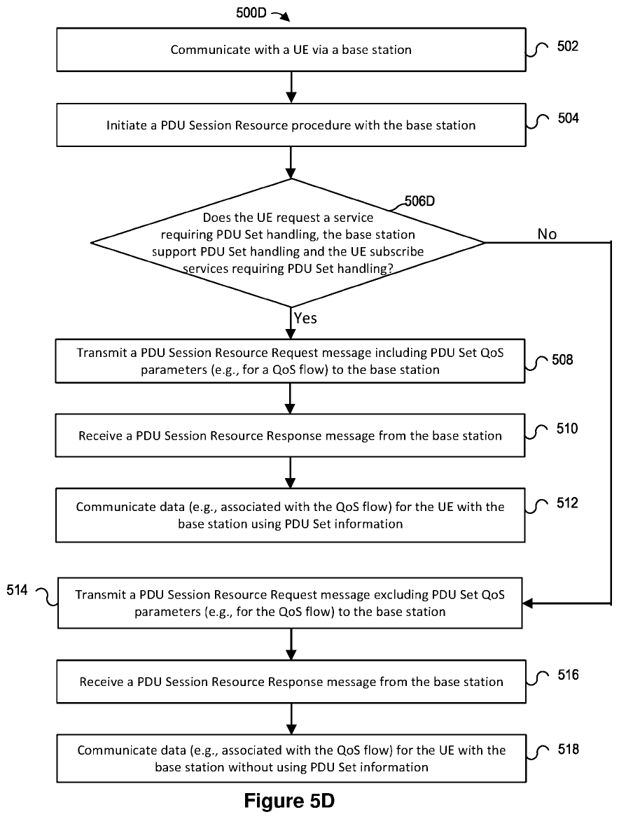

FIG. 5A is a flow diagram of an example method 500A for transmitting PDU Set QoS parameters to a base station (e.g., the base station 104 or 106) for PDU Set based QoS handling, which a CN (e.g., the CN 110 or AMF 164) can implement.

The method 500A begins at block 502, where the CN communicates with a UE (e.g., UE 102) via a base station (e.g., events 302, 304). At block 504, the CN initiates a PDU Session Resource procedure with the base station. At block 506A, the CN determines whether the UE requests a service requiring PDU Set based QoS handling in response to the initiation. If the CN determines that the UE requests a service requiring PDU Set based QoS handling at block 506A, the flow proceeds to block 508. At block 508, the CN transmits a PDU Session Resource Request message including PDU Set QoS parameters (e.g., for a QoS flow) to the base station (e.g., event 312). At block 510, the CN receives a PDU Session Resource Response message from the base station (e.g., event 318). At block 512, the CN communicates data (e.g., associated with the QoS flow) for the UE with the base station using PDU Set information (e.g., event 324). Otherwise, if the CN determines that the UE does not request a service requiring PDU Set based QoS handling at block 506A, the flow proceeds to block 514. At block 514, the CN transmits a PDU Session Resource Request message excluding PDU Set QoS parameters (e.g., for the QoS flow) to the base station. At block 516, the CN receives a PDU Session Resource Response message from the base station. At block 518, the CN communicates data (e.g., associated with the QoS flow) for the UE with the base station without using PDU Set information (e.g., event 324).

FIG. 5B is a flow diagram of an example method 500B similar to the method 500A, except that the method 500B includes block 506B instead of block 506A. At block 506B, the CN determines whether the UE subscribes to services requiring PDU Set based QoS handling. If the CN determines that the UE subscribes to services requiring PDU Set based QoS handling at block 506B, the flow proceeds to block 508. Otherwise, if the CN determines that the UE does not subscribe to services requiring PDU Set based QoS handling at block 506B, the flow proceeds to block 514.

FIG. 5C is a flow diagram of an example method 500C similar to the method 500A, except that the method 500C includes block 506C instead of block 506A. At block 506C, the CN determines whether the UE requests a service requiring PDU Set based QoS handling and the UE subscribes to services requiring PDU Set based QoS handling. If the CN determines that the UE requests a service requiring PDU Set based QoS handling and the UE subscribes to services requiring PDU Set based QoS handling at block 506C, the flow proceeds to block 508. Otherwise, if the CN determines that the UE does not request a service requiring PDU Set based QoS handling and/or the UE does not subscribe to services requiring PDU Set handling at block 506C, the flow proceeds to block 514.

FIG. 5D is a flow diagram of an example method 500D similar to the method 500A, except that the method 500D includes block 506D instead of block 506A. At block 506D, the CN determines whether the UE requests a service requiring PDU Set based QoS handling, the base station supports PDU Set based QoS handling, and the UE subscribes to services requiring PDU Set based QoS handling. If the CN determines that the UE requests a service requiring PDU Set handling, the base station supports PDU Set handling, and the UE subscribes to services requiring PDU Set handling at block 506D, the flow proceeds to block 508. Otherwise, if the CN determines that the UE does not request a service requiring PDU Set handling, the base station does not support PDU Set based QoS handling and/or the UE does not subscribe to services requiring PDU Set based QoS handling, the flow proceeds to block 514.

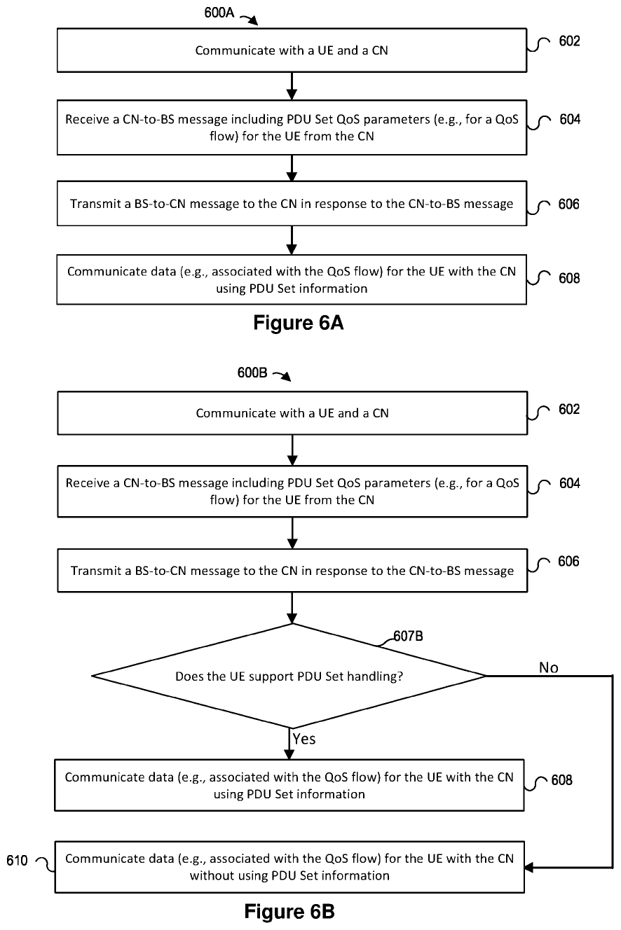

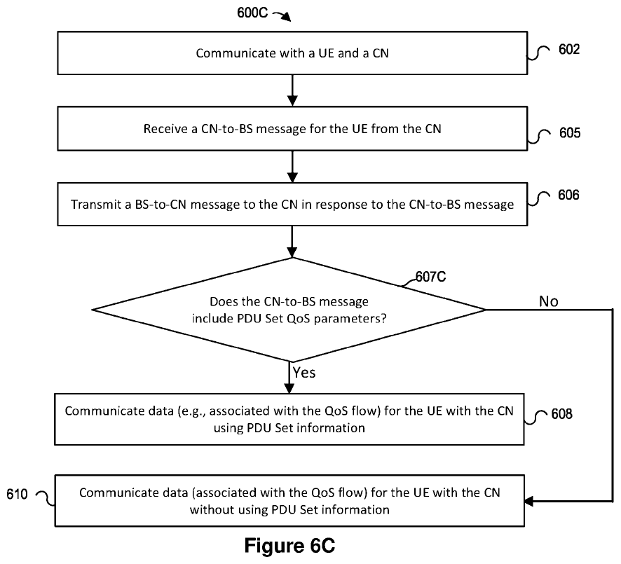

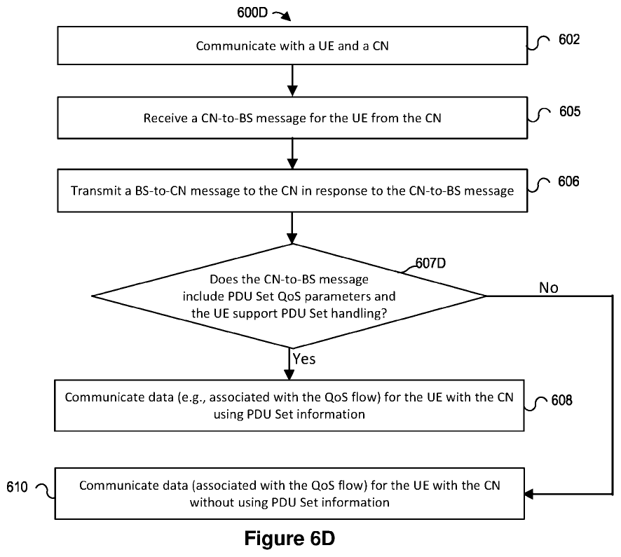

FIG. 6A is a flow diagram of an example method 600A for performing PDU Set based QoS handling on data received from a CN (e.g., the CN 110 or UPF 162), which a base station (e.g., the base station 104 or 106) can implement.

The method 600A begins at block 602, where the base station communicates with a UE (e.g., UE 102) and a CN (e.g., events 302, 304, 306). At block 604, the base station receives a CN-to-BS message including PDU Set QoS parameters (e.g., for a QoS flow) for the UE from the CN (e.g., event 312). At block 606, the base station transmits a BS-to-CN message to the CN in response to the CN-to-BS message (e.g., event 318). At block 608, the base station communicates data (associated with the QoS flow) for the UE with the CN using PDU Set information (e.g., event 324).

FIG. 6B is a flow diagram of an example method 600B similar to the method 600A, except that the method 600B includes blocks 607B and 610. At block 607B, the base station determines whether the UE supports PDU Set handling. For example, the PDU Set handling includes a discard operation of a PDU Set and/or delay reporting for a PDU Set. If the base station determines that the UE supports PDU Set handling at block 607B, the flow proceeds to block 608. Otherwise, if the base station determines that the UE does not support PDU Set handling at block 607B, the flow proceeds to block 610. At block 610, the base station communicates data (e.g., associated with the QoS flow) for the UE with the CN without using PDU Set information (e.g., event 324).

FIG. 6C is a flow diagram of an example method 600C similar to the method 600B, except that the method 600C includes blocks 605 and 607C instead of blocks 604 and 607B. At block 605, the base station receives a CN-to-BS message for the UE from the CN (e.g., event 312). At block 607C, the base station determines whether the CN-to-BS message includes PDU Set QoS parameters (e.g., for a QoS flow). If the base station determines that the CN-to-BS message includes PDU Set QOS parameters at block 607C, the flow proceeds to block 608. Otherwise, if the base station determines that the CN-to-BS message does not include PDU Set QoS parameters, the flow proceeds to block 610.

FIG. 6D is a flow diagram of an example method 600D similar to the method 600C, except that the method 600D includes block 607D instead of block 607C. At block 607D, the base station determines whether the CN-to-BS message includes PDU Set QoS parameters and the UE supports PDU Set handling. If the base station determines that the CN-to-BS message includes PDU Set QoS parameters and the UE supports PDU Set handling at block 607D, the flow proceeds to block 608. Otherwise, if the base station determines that the CN-to-BS message does not include PDU Set QoS parameters and/or the UE does not support PDU Set handling at block 607D, the flow proceeds to block 610.

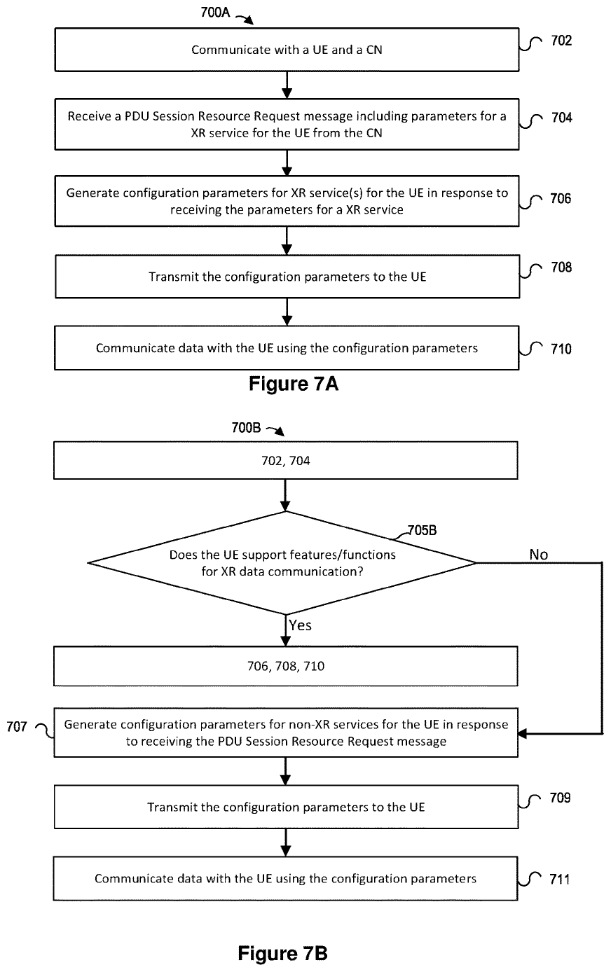

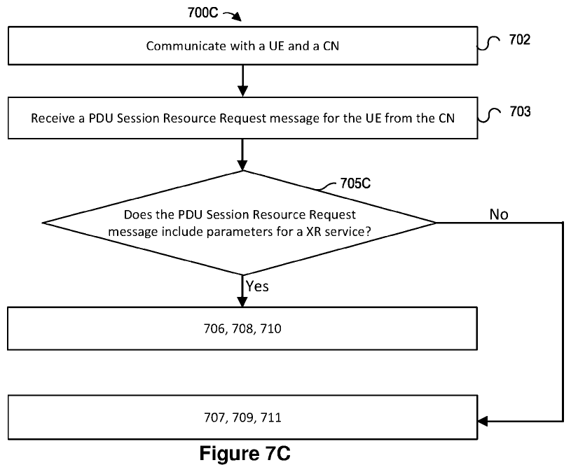

FIG. 7A is a flow diagram of an example method 700A for generating configuration parameters for XR services and transmitting the configuration parameters to a UE (e.g., the UE 102) performing the XR service, which a base station (e.g., the base station 104 or 106) can implement.

The method 700A begins at block 702, where the base station communicates with a CN (e.g., CN 110) and a UE (e.g., events 302, 304, 306). At block 704, the base station receives a PDU Session Resource Request message including one or more parameters for an XR service for the UE from the CN (e.g., event 312). At block 706, the base station generates configuration parameters for an XR service for the UE in response to receiving the parameter(s) for an XR service. At block 708, the base station transmits the configuration parameters to the UE (e.g., event 314). At block 710, the base station communicates data with the UE using the configuration parameters (e.g., event 324).

In some implementations, the parameter(s) in block 704 includes PDU Set QoS parameters. In other implementations, the parameter(s) includes an S-NSSAI configured for one or more XR services.

FIG. 7B is a flow diagram of an example method 700B similar to the method 700A, except that the method 700B includes blocks 705B, 707, 709, and 711. At block 705B, the base station determines whether the UE supports features and/or functions for XR data communication. If the base station determines that the UE supports features and/or functions for XR data communication at block 705B, the flow proceeds to blocks 706, 708, and 710.

Otherwise, if the base station determines that the UE does not support features and/or functions for XR data communication at block 705B, the flow proceeds to block 707. At block 707, the base station generates configuration parameters for non-XR services for the UE in response to receiving the PDU Session Resource Request message. At block 709, the base station transmits the configuration parameters to the UE. At block 711, the base station communicates data with the UE using the configuration parameters.

FIG. 7C is a flow diagram of an example method 700C similar to the method 700B, except that the method 700C includes blocks 703 and 705C instead of blocks 702 and 705B. At block 703, the base station receives a PDU Session Resource Request message for the UE from the CN (e.g., event 312). At block 705C, the base station determines whether the PDU Session Resource Request message includes one or more parameters for an XR service. If the base station determines that the PDU Session Resource Request message includes parameter(s) for an XR service, the flow proceeds to blocks 706, 708, and 710. Otherwise, if the base station determines that the PDU Session Resource Request message does not include parameter(s) for an XR service, the flow proceeds to blocks 707, 709, and 711.

The following additional considerations apply to the foregoing discussion.

In some implementations, the paging message can be replaced by a paging record. In other implementations, the paging message can include one or more paging records, where each paging record pages a particular UE. For example, the paging message can include a paging record for the UE 102.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method implemented in core network (CN), the method comprising:
transmitting, to a base station via which a user equipment (UE) communicates with the CN, a request for resources for a packet data unit (PDU) session, including:
determining, based on a condition related to the UE and/or the base station, whether to include a PDU Set quality of service (QOS) parameter for a QoS flow of the PDU session in the request; and
receiving, from the base station, a response to the request for the resources.

2. The method of claim 1, wherein:
the condition is the UE requesting a service requiring PDU Set QoS handling.

3. The method of claim 1, wherein:
the condition is the UE subscribing to a service requiring PDU Set QoS handling.

4. The method of claim 1, wherein:
the condition is a first condition, the determining is further based on a second condition;
the first condition is the UE requesting a service requiring PDU Set QoS handling; and
the second condition is the UE subscribing to a service requiring PDU Set QoS handling.

5. The method of claim 1, wherein:
the condition is the base station supporting a service requiring PDU Set QoS handling.

6. The method of any one of the preceding claims, further comprising:
when determining to include the PDU QoS parameter in the request, including in the request one or more of:
(i) a PDU Set Delay Budget (PSDB),
(ii) a PDU Set Error Rate (PSER), or
(iii) a PDU Set Integrated Handling Information (PSIHI).

7. The method of any one of claims 1-5, further comprising:
when determining to exclude the PDU QoS parameter in the request, including a non-PDU Set QoS parameter in the request, the non-PDU Set QoS including one or more of:
(i) a QoS flow identifier,
(ii) a QoS identifier descriptor,
(iii) a maximum flow bit rate for downlink(DL),
(iv) a maximum flow bit rate for uplink (UL),
(v) a guaranteed flow bit rate for the DL, or
(vi) a guaranteed flow bit rate for the UL.

8. The method of one any of claims 1-7, wherein:
the response indicates that the base station applies the PDU Set QoS parameter;
the method further comprising:
communicating data packets in a QoS flow associated with the PDU session using PDU Set information.

9. The method of claim 8, wherein:
the PDU Set information includes, for a PDU set, at least one of:
(i) a sequence number of the PDU Set,
(ii) an indication of an end PDU in the PDU Set,
(iii) a PDU sequence number within the PDU Set,
(iv) a size of the PDU Set,
(v) an importance indicator for the PDU Set.

10. A method implemented in base station (BS), the method comprising:
receiving, from a core network (CN) for a user equipment (UE), a request for resources for a packet data unit (PDU) session, the request including a parameter pertaining to one of (i) a PDU Set quality of service (QoS) for a QOS flow of the PDU session or (ii) an extended Reality (XR) service;
determining, based on a condition related to the UE, whether to communicate a data packet between the UE and the CN using information corresponding to the parameter; and
communicating the data packet in accordance with the determining.

11. The method of claim 10, wherein:
the parameter pertains to the PDU Set QoS; and
the information corresponding to the parameter includes a PDU Set information received from
the CN along with the data packet.

12. The method of claim 10, wherein:
the parameter pertains to the XR service;
the method further comprising:
generating, at the BS, a configuration parameter for XR service using the parameter;
wherein the information corresponding to the parameter includes the configuration parameter.

13. The method of claim 10, further comprising:
transmitting, to the CN in response to the request, a response including an indication that the base station supports the parameter.

14. The method of claim 10, wherein:
the condition is the UE supporting PDU Set QoS handling.

15. A device in a core network (CN), comprising:
processing hardware; and configured a transceiver, the device configured to:
transmit, to a base station via which a user equipment (UE) communicates with the CN, a request for resources for a packet data unit (PDU) session, including:
determining, based on a condition related to the UE and/or the base station, whether to include a PDU Set quality of service (QoS) parameter for a QoS flow of the PDU session in the request; and
receiving, from the base station, a response to the request for the resources.

16. The device of claim 15, wherein the request additionally includes a request for at least one QoS parameter not related to the PDU Set.

17. The device of claim 15, wherein:
the condition is the UE requesting a service requiring PDU Set QoS handling.

18. The device of claim 15, wherein:
the condition is the UE subscribing to a service requiring PDU Set QoS handling.

19. The method of claim 1, wherein the request additionally includes a request for at least one QoS parameter not related to the PDU Set.

20. The method of claim 10, wherein the request additionally includes a request for at least one QoS parameter not related to the PDU Set.
